(19) United States
(12) Patent Application Publication
(10) Pub. No.: US 2025/0008486 A1
(43) Pub. Date: Jan. 2, 2025

(54) METHOD AND SYSTEM FOR PAGING RESTRICTION IN MUSIM

(71) Applicant: Samsung Electronics Co., Ltd., Suwon-si (KR)

(72) Inventors: Prasad Basavaraj DANDRA, Bengaluru (IN); Chetan Ramesh GANIG, Bengaluru (IN); Sivasankar COMARAVELOU, Bengaluru (IN); Umasankar Baskar CEENDHRALU, Bengaluru (IN); Lalith KUMAR, Bengaluru (IN)

(21) Appl. No.: 18/711,518

(22) PCT Filed: Nov. 16, 2022
(86) PCT No.: PCT/KR2022/018118

§ 371 Date: May 17, 2024

(30) Foreign Application Priority Data
Nov. 17, 2021 (IN) 202141052820

(51) Int. Cl. H04W 68/02; H04W 60/04

(52) U.S. Cl. CPC H04W 68/02; H04W 60/04

(57) ABSTRACT

The present subject matter refers to methods and systems for managing paging restriction in Multi SIM Multi Standby (MUSIM). The method performed by a user equipment (UE) (101) comprises transmitting (202), to a network entity (106), a request message including paging restriction information. Further, the method includes receiving (204), from the network entity, a request accept message including an indication of an implementation of a paging restriction between the network entity and the UE based on the paging restriction information included in the registration request message. Thereafter, the method includes transmitting, to the network entity, a release request message including information related to a release of the paging restriction for the UE when the UE intend to receive paging messages from the network entity. Moreover, in response to a reception of the release request message, the network entity releases the paging restriction for the UE.

### FIELD OF THE INVENTION

The present disclosure relates to methods and system for managing paging restriction in a Multi SIM Multi Standby (MUSIM) scenario.

### BACKGROUND

In mobile communication, a Multi Universal Subscriber Identity Module (Multi-USIM) user equipment (UE) registered over a network, receives multiple paging messages (also referred as “paging”) for implementing various functionalities of the network. Sometimes, such paging messages by the network may be undesired by the UE and creates a congestion at the UE. In fact, in some scenarios such undesired paging messages may impact an ongoing process at the UE.

Thus, with recent development in mobile communication, the UE and the network have been enhanced to support paging restriction. The paging restrictions may be implemented by the UE to prevent unwanted paging messages. When paging restriction is supported by the UE and the network, the UE may enable paging restrictions either for all the services or for a selected services by the network. Thus, by implementing paging restriction, the UE may avoid unnecessary processing and decoding of the paging messages for the services which is not desired by the UE.

Generally, the UE indicates a requested paging restriction in Registration or a Service Request to the Access and Mobility Management Function (AMF) entity of the network. When the request for the paging restriction is accepted and activated, both the UE and the AMF maintain paging restriction information. The paging restriction information includes indication to specific requests by the UE for example such as, all paging is restriction, or all paging is restricted, except paging for voice service (IP Multimedia Subsystem (IMS) voice), or all paging is restricted, except for certain Packet Data Bearer (PDU) session(s), or all paging is restricted, except paging for voice service and certain PDU sessions. However, there are various defects in the current procedure which causes the deletion of paging restriction information maintained at the AMF.

Unwanted deletion of paging restriction information cause various problem, such as enabling paging for all services wrongly, delayed in data sessions, resource wastage, and inconsistent UE and AMF behavior. Further, in some instances, N1 Non-Access Stratum (N1 NAS) signaling connection gets released abnormally, which delays normal services.

Generally, when the UE and the network supports paging restriction feature of MultiSIM, the UE sets a connection to respond to a page with a Reject Paging Indication to the network indicating that the UE does not accept the paging and requests to return to an idle state after sending the response. In addition, the UE may also include the paging restriction information in the response including the Reject Paging Indication. Conventionally, if no paging restriction information is provided by the UE, any previously stored Paging Restriction in context of the UE is removed by the AMF. The AMF may further stop paging restriction, which may be undesired by the UE.

Also, in some scenarios, the UE and the network fail to effectively maintain signaling connection. For example, the UE and the network may remain in connected state even when signaling is handled during paging restriction. Such connected state of UE results into wastage of network resources.

Thus, there is a need to overcome above-mentioned problems in the mobile communication network. Specifically, there is a need to provide methods and system for effective and efficient maintaining of paging restriction and N1 NAS signaling connection.

### SUMMARY

This summary is provided to introduce a selection of concepts in a simplified format that are further described in the detailed description of the invention. This summary is not intended to identify key or essential inventive concepts of the invention, nor is it intended for determining the scope of the invention.

According to one embodiment of the present disclosure, a method performed by a user equipment (UE) in a wireless communication system is disclosed. The method includes transmitting, to a network entity, a request message including paging restriction information. The method also includes receiving, from the network entity, a request accept message including an indication of an implementation of a paging restriction between the network entity and the UE based on the paging restriction information included in the request message. Thereafter, the method includes transmitting, to the network entity, a release request message including information related to a release of the paging restriction for the UE when the UE intend to receive paging messages from the network entity. In response to a reception of the release request message, the network entity releases the paging restriction for the UE and further releases the signaling connection if no pending data or signaling.

According to another embodiment of the present disclosure, a method performed by a network entity in a wireless communication system is disclosed. The method includes receiving, from a user equipment (UE), a request message including paging restriction information. The method also includes implementing paging restriction for the UE based on the paging restriction information included in the registration request message. The method further includes transmitting, to the UE, a request accept message including an indication of an implementation of a paging restriction between the network entity and the UE based on the paging restriction information. Furthermore, the method includes receiving, from the UE, a release request message including information related to a release of the paging restriction for the UE when the UE intend to receive paging messages from the network entity. In response to a reception of the release request message, the method includes releasing the paging restriction for the UE.

According to yet another embodiment of the present disclosure, a method performed by a user equipment (UE) in a wireless communication system is disclosed. The method includes transmitting, to a network entity, a service request message indicating a request for a service from the network entity while a paging restriction is maintained between the UE and network entity. The method also includes receiving, from the network entity, a service accept message indicating an acceptance of the request for the service when a connection between the UE and network entity has been established by the network entity based on the service request message. The method further includes determining a completion of a signaling procedure over the established connection. Further, in response to the determination of the completion of the signaling procedure over the established connection, the method includes releasing the established signaling connection while maintaining the paging restriction between the UE and the network entity. Furthermore, the method includes transmitting, to the network entity, a release request message including information related to a release of the maintained paging restriction for the UE when the UE intend to receive paging messages from the network entity. In response to a reception of the release request message, the network entity releases the paging restriction for the UE and the signaling connection if no pending data or signaling.

According to yet another embodiment of the present disclosure, a method performed by a network entity in a wireless communication system is disclosed. The method includes receiving, from a user equipment (UE), a service request message indicating a request for a service from the network entity while a paging restriction is maintained between the UE and network entity. The method also includes transmitting, to the UE, a service accept message indicating an acceptance of the request for the service after a successful establishment of a connection between the UE and network entity based on the service request message. The method further includes determining a completion of a signaling procedure over the established connection. Further, in response to the determination of the completion of the signaling procedure over the established connection, the method includes releasing the established connection while maintaining the paging restriction between the UE and the network entity. Furthermore, the method includes receiving, from the UE, a release request message including information related to a release of the paging restriction for the UE when the UE intend to receive paging messages from the network entity. In response to a reception of the release request message, the method includes releasing the paging restriction for the UE.

To further clarify the advantages and features of the present invention, a more particular description of the invention will be rendered by reference to specific embodiments thereof, which is illustrated in the appended drawing. It is appreciated that these drawings depict only typical embodiments of the invention and are therefore not to be considered limiting its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a sequence of operation depicting a problem of deletion of paging restriction, according to the conventional state of art;

FIG. 2 illustrates an exemplary process flow depicting a method for solving the problem of FIG. 1, according to an embodiment of the present disclosure;

FIG. 3 illustrates an exemplary process flow depicting a method for solving the problem of FIG. 1, according to another embodiment of the present disclosure;

FIG. 4 illustrates a sequence of operation depicting a problem associated with signaling connection, according to the conventional state of art;

FIG. 5 illustrates an exemplary process flow depicting a method for solving the problem of FIG. 4, according to an embodiment of the present disclosure;

FIG. 6 illustrates an exemplary process flow depicting a method for solving the problem of FIG. 4, according to another embodiment of the present disclosure;

FIG. 7 illustrates a sequence of operation depicting a problem associated with signaling connection, according to the conventional state of art;

FIG. 8 illustrates a sequence of operation of a method for solving the problem of FIG. 7, according to an embodiment of the present disclosure;

FIG. 9 illustrates a sequence of operation depicting a problem associated with NAS signaling connection, according to the conventional state of art;

FIG. 10 illustrates a sequence of operation of a method for solving the problem of FIG. 9, according to an embodiment of the present disclosure;

FIG. 11 illustrates a sequence of operation depicting a method for effectively maintaining and releasing paging restriction and NAS signaling connection, according to an embodiment of the present disclosure;

FIG. 12 illustrates a sequence of operation depicting a problem associated with paging restriction, according to the conventional state of art;

FIG. 13 illustrates exemplary diagram of a network, according to an embodiment of the present disclosure; and

FIG. 14 is a diagram illustrating the configuration of a user equipment (UE) in a wireless communication system, according to an embodiment of the present disclosure.

Further, skilled artisans will appreciate that elements in the drawings are illustrated for simplicity and may not have been necessarily drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

It should be understood at the outset that although illustrative implementations of the embodiments of the present disclosure are illustrated below, the present invention may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more.” or “one or more element is REQUIRED.”

Unless otherwise defined, all terms, and especially any technical and/or scientific terms, used herein may be taken to have the same meaning as commonly understood by one having ordinary skill in the art.

Embodiments of the present invention will be described below in detail with reference to the accompanying drawings.

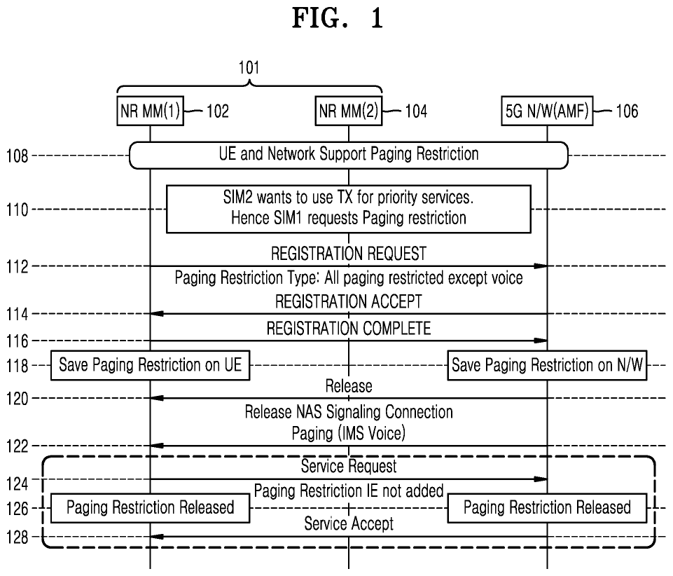

FIG. 1 illustrates a sequence of operation depicting a problem of deletion of paging restriction, according to the conventional state of art. In this scenario, the sequence of operation corresponds to a communication between a User Equipment (UE) and Access and Mobility Management Function (AMF) entity 106 (interchangeably referred as “the network 106”). The UE may be a Multi Subscriber Identity Module (SIM) Multi Standby MUSIM UE. In an exemplary embodiment, the UE may be a dual SIM device. In the illustrated embodiment, New Radio (NR) Mobility Management 1 (MM1) may correspond to SIM1 of the UE and NR MM2 corresponds to SIM2 of the UE. Accordingly, NR MM1 102 may be referred as SIM1 102 and NR MM2 104 may be referred as SIM2 104. In an embodiment, the SIM1 102 and SIM2 104 may be implemented by a single UE 101. Further, the AMF 106 may be a Serving Network (SN) capable of supporting MUSIM operations.

Further, the method may consider an assumption that both the UE 101 and the network support paging restriction, as shown by step 108. Moreover, in the exemplary scenario, SIM2 104 wants to use transmission (TX) for priority services and therefore, SIM1 102 requests for paging restriction, as shown in step 110. In an exemplary embodiment, the UE 101 may detect change in priority of services and/or signaling procedure to initiate a request for the paging restriction. At step 112, the SIM1 102 initiates a registration procedure by sending a REGISTRATION REQUEST message to the AMF 106. The REGISTRATION REQUEST message may include requested Paging Restriction Information (interchangeably referred to as “Paging Restriction Information Element (IE)). In an exemplary embodiment, the paging restriction information may indicate that the SIM1 102 would like to restrict all the paging except for voice services. In an embodiment, the UE 101 may enable paging restriction for all services by the network or enable paging only for specific services or Packet Data Units (PDUs) or both. By enabling the paging restriction, the UE 101 may skip processing and decoding of undesired paging services. In some other embodiments, the paging restriction information may be included in a SERVICE REQUEST message by the UE 101. Further, at step 114, the AMF 106 accepts the registration request to implement the paging restriction and send a REGISTRATION ACCEPT message to the SIM1 102. The REGISTRATION ACCEPT message may indicate that the paging restriction has been successfully handshake between the UE 101 and the network 106 i.e., the network 106 may not page the UE 101 for the services/PDUs for which paging restriction has been indicated. In alternative embodiment, the AMF 106 may reject the request for paging restriction and indicate the same in the registration accept and/or service accept message. Once the registration request is accepted by the AMF 106, the SIM1 102 transmits REGISTRATION COMPLETE message to the AMF 106, as shown in step 116. Further, at step 118, both the UE 101 and AMF 106 of the network may save the shared paging restriction information. At step 120, the AMF 106 releases Non-Access Stratum (NAS) signaling connection. At step 122, the AMF 106 pages the UE 101 with voice service indication when the UE 101 is in idle mode. Next at step 124, the SIM1 102 initiates a service request by transmitting a SERVICE REQUEST message to the AMF 106, in response to the paging with type as voice service indication. However, the service request may not include paging restriction Information Element (IE). At step 126, after the initialization of service request without the paging restriction IE, both the UE 101 and the network 106 release paging restriction, which may not be desired by the user. At step 128, the AMF 106 may accept the service request and transmit a SERVICE ACCEPT message. However, the unwanted release of paging restricted may be highly undesirable by the UE 101. Further the release of paging restriction may impact other operations of the UE 101. For example, the unwanted release of paging restriction, may initiate undesired paging by the AMF 106 which may impact priority services of the SIM2 104. Therefore, the conventional state of art requires the paging restriction IE to be included in every REGISTRATION and/or SERVICE request. However, including the paging restriction IE in every REGISTRATION and/or SERVICE request may not be practical, as it may impact other services due to overhead of remembering the previous restrictions and applying it again with additional signaling steps along with RF resource conflict resolution between the SIMs to perform this signaling. In some embodiments, the deletion of paging restriction context/information may enable paging for all the services wrongly. Further, the deletion of paging restriction may delay resuming data session or may impact normal services by the network. Moreover, the undesired paging may result into resource wastage due to unnecessary signaling or user plane establishment. Also, in some scenarios, the deletion of paging restriction may lead to inconsistent UE and the AMF behavior.

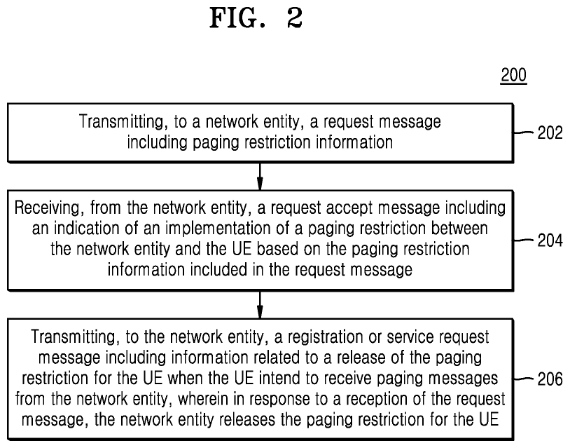

FIG. 2 illustrates an exemplary process flow depicting a method 200 for solving the problems of FIG. 1, according to an embodiment of the present disclosure. The method 200 may be performed by the UE 101 (shown in FIG. 1) in a wireless communication system. The UE 101 may include SIM1 102 and SIM2 104. In an exemplary embodiment, the wireless communication system may correspond to 5G communication system. Alternatively, the wireless communication system may correspond any suitable communication system.

At step 202, the method 200 may include transmitting, to a network entity (i.e., AMF 106), a request (REGISTRATION REQUEST or SERVICE REQUEST) message including paging restriction information. In an embodiment, the step 202 may correspond to step 112, as shown in FIG. 1. Next at step 204, the method 200 may include receiving a request accept (REGISTRATION ACCEPT or SERVICE ACCEPT) message from the network entity 106. The request accept message may include an indication of an implementation of a paging restriction between the network entity 106 and the UE 101 based on the paging restriction information included in the request message. In an embodiment, the step 204 may correspond to step 114, as shown in FIG. 1. With request accept message, the UE 101 and the network entity 106 may save the paging restriction information. In an embodiment, the paging restriction information may include indication to one or more services or one or more protocol data units (PDUs) for which the UE intend to implement the paging restriction. In some embodiment, the UE 101 may determine a priority level of activities performed by SIM1 102 or SIM2 104, and/or the UE 101. Further, the method 200 may include determining the one or more services or the one or more PDUs for paging restriction based at least on the priority level of an activity to be performed by the UE 101.

In an embodiment, the method 200 may include transmitting a service request message due to reception of paging message for establishing an IMS call. This service request message should not be interpreted as paging restriction release which corresponds to step 122, as shown in FIG. 1. At step 206, the method 200 may include transmitting release request message to the network entity 106. The release request message may include information related to a release of the paging restriction for the UE 101 when the UE 101 intend to receive paging messages from the network entity 106. In an exemplary embodiment, in response to a reception of the release request message, the network entity 106 may release the paging restriction for the UE. In an exemplary embodiment, the release request message includes at least one of a REGISTRATION REQUST or a SERVICE REQUEST with a “Paging Restriction Release” cause. The “Paging Restriction Release” cause may indicate that the UE intent to receive paging messages which has been initially restricted by the UE 101. Therefore, the network entity 106 may only release the paging restriction when explicitly requested by the UE 101. Otherwise, both the UE 101 and the network entity 106 may maintain the paging restriction. Specifically, the UE 101 and the network 106 may maintain paging restriction even when the network receives Registration Request or Service Request without paging restriction information. Thus, the method 200 may overcome problem explained in reference to FIG. 1.

In another embodiment, the UE 101 may initiate another registration request or service request with paging restriction after completion on ongoing procedure which may release the previously save paging restriction information.

In some alternative embodiments, the UE may include paging restriction information in each Service Request message when the paging restriction need to be maintained at the UE and the network entity 106. In some embodiments, prior to establishment of paging restriction, the method 200 may include receiving an indication from the network entity 106. The indication may indicate that the network entity 106 supports paging restriction. Thus, upon receiving the indication that the network entity supports paging restriction, the method 200 may include transmitting the registration request message including the paging restriction information to the network entity 106.

Embodiments are exemplary in nature and the steps of the method 200 as shown in FIG. 2 may occur in variations to the sequence in accordance with various embodiments. The variation may include addition and/or omission of steps illustrated in FIG. 2.

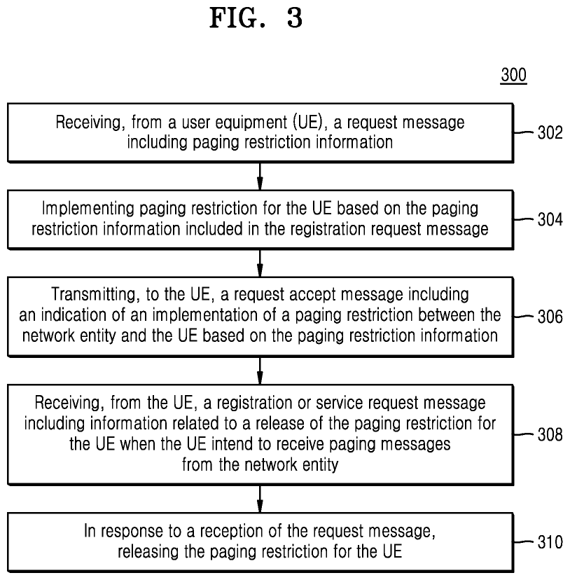

FIG. 3 illustrates an exemplary process flow depicting a method 300 for solving the problem of FIG. 1, according to another embodiment of the present disclosure. The method 300 may be performed by the network 106 of the wireless communication system.

At step 302, the method 300 may include receiving a request (REGISTRATION REQUEST or SERVICE REQUEST) message including paging restriction information from the UE 101. The step 302 may correspond to step 112, as shown in FIG. 1. Further, at step 304, the method 300 may include implementing paging restriction for the UE 101 based on the paging restriction information included in the request message.

Next at step 306, the method 300 may include transmitting a request accept (REGISTRATION ACCEPT or SERVICE ACCEPT) message to the UE 101. The request accept message may include an indication of an implementation of a paging restriction between the network entity 106 and the UE 101 based on the paging restriction information. In an embodiment, the step 306 may correspond to step 114, as shown in FIG. 1.

In an embodiment, the method 300 may also include transmitting of paging due to trigger of IMS call by another UE and receiving a service request message from UE 101 to establish the connection, but not releasing the paging restriction at network 106 as this request is for IMS voice call establishment.

At step 308, the method 300 may include receiving a release request message from the UE 101. The release request message may include information related to a release of the paging restriction for the UE 101 when the UE 101 intend to receive paging messages from the network entity 106. At step 310, in response to a reception of the release request message, the method 300 may include releasing the paging restriction for the UE 101. Thus, the network entity 106 may be configured to release paging restriction only when explicitly requested by the UE 101. Otherwise, in all other possible scenarios, the network entity 106 may be configured to maintain the paging restriction. In an exemplary, the release request message may correspond the release request message discussed in FIG. 2.

Further, the method 300 may include transmitting an indication to the UE 101, indicating that the network entity supports paging restriction.

Embodiments are exemplary in nature and the steps of the method 300 as shown in FIG. 3 may occur in variations to the sequence in accordance with various embodiments. The variation may include addition and/or omission of steps illustrated in FIG. 3.

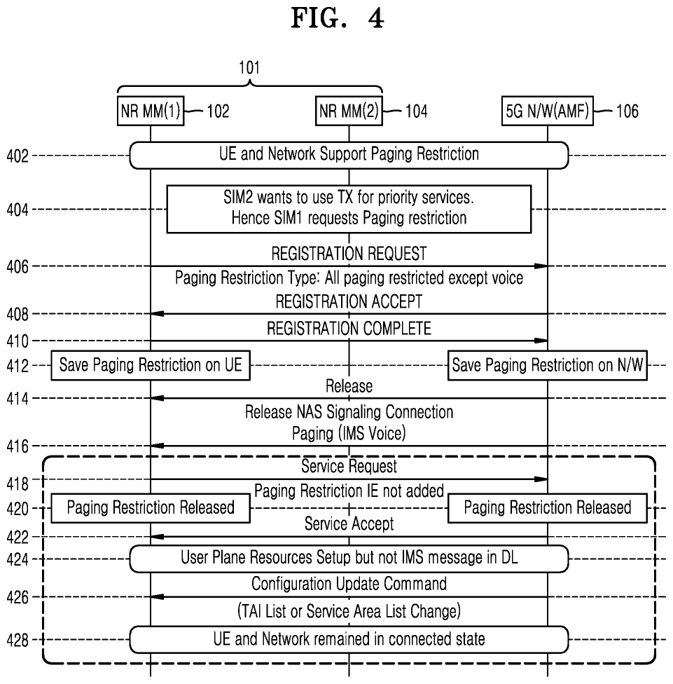

FIG. 4 illustrates a sequence of operation depicting a problem associated with signaling connection, according to the conventional state of art. Further, similar to FIG. 1, the sequence of operation corresponds to communication between the User Equipment (UE) 101 and the Access and Mobility Management Function (AMF) entity 106 of the network.

Moreover, the steps 402-422 are similar to steps 108-128 of FIG. 1, thus a description of the steps 402-422 have been omitted for the sake of brevity. Specifically, the step 402-422 relates to establishment of paging restriction between the UE 101 and the AMF 106 and unwanted release of the paging restriction when the UE 101 triggers a Service Request procedure.

Step 424 indicates that a user plane resource may be setup. However, in the illustrated scenario there are no IP Multimedia Subsystem (IMS) voice messages in Downlink (DL). Specifically, step 424 indicates that there is no IMS voice related control packet in DL from the network even after a successful Data Resource Bearer (DRB) setup in connected state. Next at step 426, the UE 101 receives a Configuration Update Command from the AMF 106. In an embodiment, the Configuration Update Command may include a change in a Tracking Arca Identity (TAI) list or a Service Area List. In alternative embodiments, the Configuration Update Command may include any other signaling information. Further, the UE may receive NAS/MM signaling messages like Steering of Roaming (SoR) messages.

However, at step 426, the UE 101 and the network 106 may remain in connected state after completion of Configuration Update Command signaling, even when there is no transmission and/or reception of data and/or information. Specifically, the UE 101 and the network 106 may remain in connected state, even when all the signaling is completed. Such connected state of the UE and the network may be undesirable, as this may result into wastage of network resources.

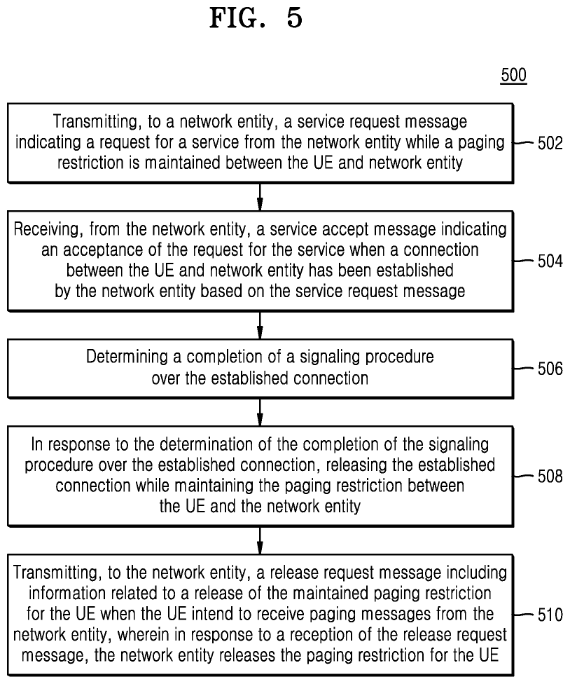

FIG. 5 illustrates an exemplary process flow depicting a method 500 for solving the problem of FIG. 4, according to an embodiment of the present disclosure. The method 500 may be performed by the UE 101 and the network entity 106 in the wireless communication system.

At step 502, the method 500 may include transmitting a service request (SERVICE REQUEST) message to a network entity 106, as shown in FIG. 4. The service request message may indicate a request for a service from the network entity 106 while a paging restriction is maintained between the UE 101 and network entity 106. Next at step 504, the method 500 may include receiving a service accept (SERVICE ACCEPT) message from the network entity 106. The service accept message may indicate an acceptance of the request for the service when a connection between the UE 101 and the network entity 106 has been established by the network entity 106 based on the service request message. Thereafter, the network entity 106 may perform a signaling procedure i.e., may transmit signaling message(s) to the UE 101.

At step 506, the method 500 may include determining a completion of the signaling procedure over the established connection. In an embodiment, the UE 101 may determine that no signaling message is available for transmission/reception and the signaling procedure has been completed. In some embodiments, the completion of signaling procedure indicates a completion of transmission of data packets or a completion of transmission of signaling messages. In an exemplary embodiment, the method 500 may include determining the completion of signaling procedure based on conditions, such as, but not limited to, a Radio Resource Control (RRC) inactive state, no pending uplink (UL) signaling, no pending UL data, or Protocol Data Unit (PDU) with no Data Radio Bearer (DRB) or network reject or no re-registration required on existing signaling.

Next at step 508, in response to the determination of the completion of the signaling procedure over the established connection, the method 500 may include releasing the established connection while maintaining the paging restriction between the UE 101 and the network entity 106. In an exemplary, the UE 101 may implement a timer prior to releasing the established connection. Further, the UE 101 may release the established connection only after the determination of the completion of signaling procedure and a lapse of a predefined time interval defined by the timer. Example of the timer may include, but not restricted to, a T3540 timer.

Further at step 510, the method 500 may include transmitting a release request message to the network entity 106. The release request message may include information related to a release of the maintained paging restriction for the UE 101 when the UE 101 intend to receive paging messages from the network entity. In response to a reception of the release request message, the network entity 106 may release the paging restriction for the UE 101.

In an embodiment, the method 500 may also include predicting loss of the paging restriction due to at least one of a service process or a registration process prior to transmitting the release request message. Further, the method 500 may include storing the previously established paging restriction information. Thereafter, the method 500 may include determining the loss of paging restriction due to at least one of the service process or the registration process and initiating at least one of another service request or registration request with stored paging restriction information.

Embodiments are exemplary in nature and the steps of the method 500 as shown in FIG. 5 may occur in variations to the sequence in accordance with various embodiments. The variation may include addition and/or omission of steps illustrated in FIG. 5.

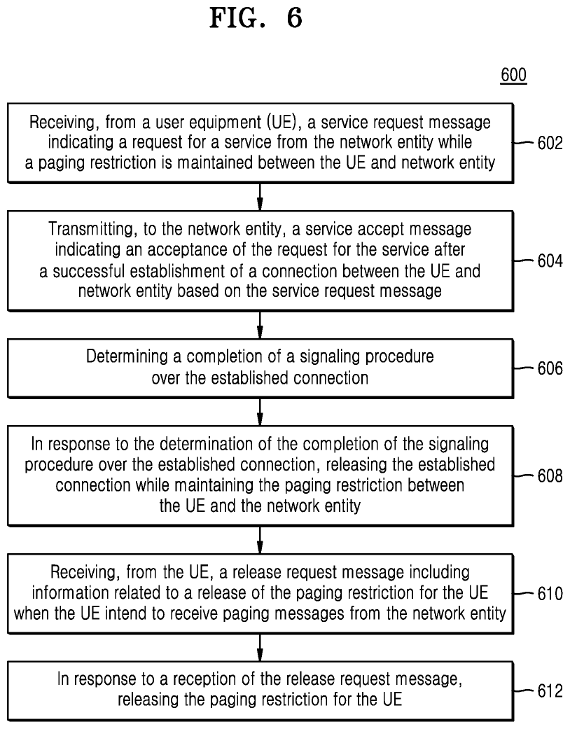

FIG. 6 illustrates an exemplary process flow depicting a method 600 for solving the problem of FIG. 4, according to another embodiment of the present disclosure. The method 600 may be performed by the network entity 106 of the wireless communication system.

At step 602, the method 600 may include receiving a service request (SERVICE REQUEST) message from the user equipment (UE) 101. The service request message may indicate a request for a service from the network entity 106 while a paging restriction is maintained between the UE 101 and network entity 106.

At step 604, the method 600 may include transmitting a service accept (SERVICE ACCEPT) message to the UE 101. The service accept message may indicating an acceptance of the request for the service after a successful establishment of a connection between the UE 101 and network entity based on the service request message.

Next at step 606, the method 600 may include determining a completion of a signaling procedure over the established connection. The network entity 106 may be configured to determine completion of the signaling procedure based on conditions such as, but not limited to, a Radio Resource Control (RRC) inactive state, no pending Downlink (DL) signaling, no pending DL data, or Protocol Data Unit (PDU) with no Data Radio Bearer (DRB) or network reject or no re-registration required on existing signaling. Further, the completion of signaling procedure may indicate scenarios such as, but not limited to, a completion of transmission of data packets, a completion of transmission of signaling messages or a completion of mobility procedure.

Further at step 608, in response to the determination of the completion of the signaling procedure over the established connection, the method 600 may include releasing the established connection while maintaining the paging restriction between the UE 101 and the network entity 106. In an exemplary embodiment, the network entity 106 may immediately release the established connection upon determining the completion of signaling procedure.

Thereafter, at step 610, the method 600 may include receiving a release request message from the UE 101. The release request message may information related to a release of the paging restriction for the UE 101 when the UE 101 intend to receive paging messages from the network entity.

Further, in response to a reception of the release request message, at step 612, the method 600 may include releasing the paging restriction for the UE 101.

Embodiments are exemplary in nature and the steps of the method 600 as shown in FIG. 6 may occur in variations to the sequence in accordance with various embodiments. The variation may include addition and/or omission of steps illustrated in FIG. 6.

Thus, the method 500 and the method 600 may enable efficient handling of N1 NAS signaling connection when there is no pending MM signaling. As explained above, the network entity 106 may immediately release the established connection after determining the completion of signaling procedure, thus saves network resources. Further, in case the network entity i.e., the AMF 106 fails to release the NAS signaling connection, the UE 101 may efficiently release the connection locally after implementing a predefined timer or through registration or service request with connection release cause to AMF 106. Further, both the UE 101 and the AMF 106 may retain the paging restriction unless an explicit request for release of paging restriction is transmitted by the UE 101 and received by the network entity 106.

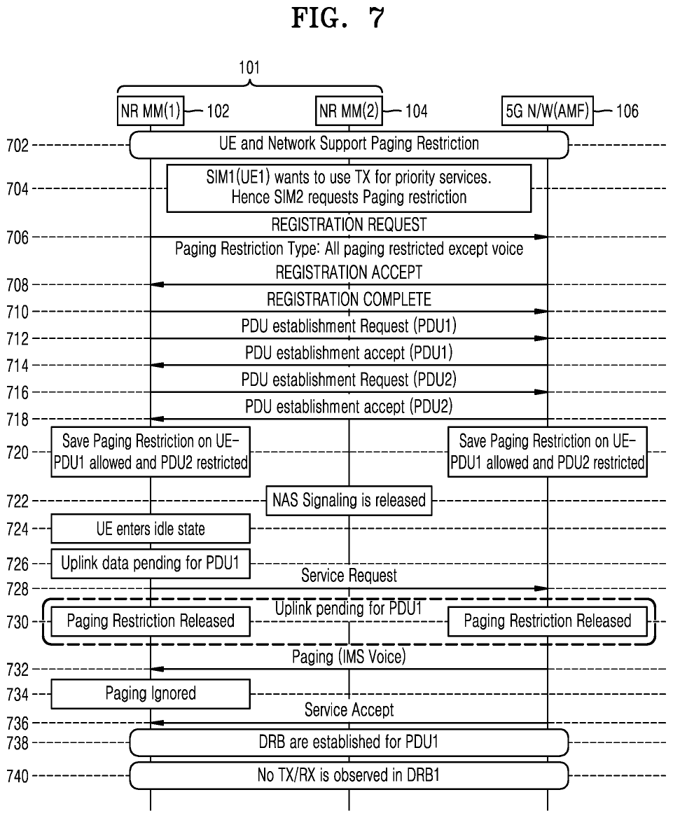

FIG. 7 illustrates a sequence of operation depicting a problem associated with signaling connection, according to the conventional state of art. The steps 702-710 are similar to steps 402-410, as shown in FIG. 4. Thus, a description of these steps has been omitted in FIG. 7 for the sake of brevity.

Steps 712-718 relates establishment of PDU1 and PDU2, based on requests received from the UE 101. At step 720, both the UE 101 and the AMF 106 store the paging restriction. The paging restriction may indicate that the PDU1 is restricted and PDU2 is allowed. Further, at step 722, the NAS signaling is released and the UE 101 enters in idle state, as shown in step 724. At step 726, the UE 101 determines that uplink data is pending for PDU1. Accordingly, at step 728, the UE 101 initiates a service request with indication that uplink pending for PDU1. However, with the initialization of the service request, the paging restriction is released by the AMF 106 and the UE 101, as shown in step 730. At step 732, the AMF 106 initiate a paging for IMS voice. At step 734, the UE 101 ignores the paging in view of ongoing service request. At step 736, the UE 101 receives the service accept indication from the AMF 106. Based on the service request and acceptance, a Data Resource Bearer (DRB) is established for PDU1, as shown in step 738. Further, at step 740, no transmission/reception is observed in the established DRB as not data was expected, and connection was established due to pending signaling for PDU1. Since the paging is ignored the data session which was possible for PDU2 doesn't happen.

In this scenario, the UE 101 and the network 106 remains in connected state which results wastage of network resources.

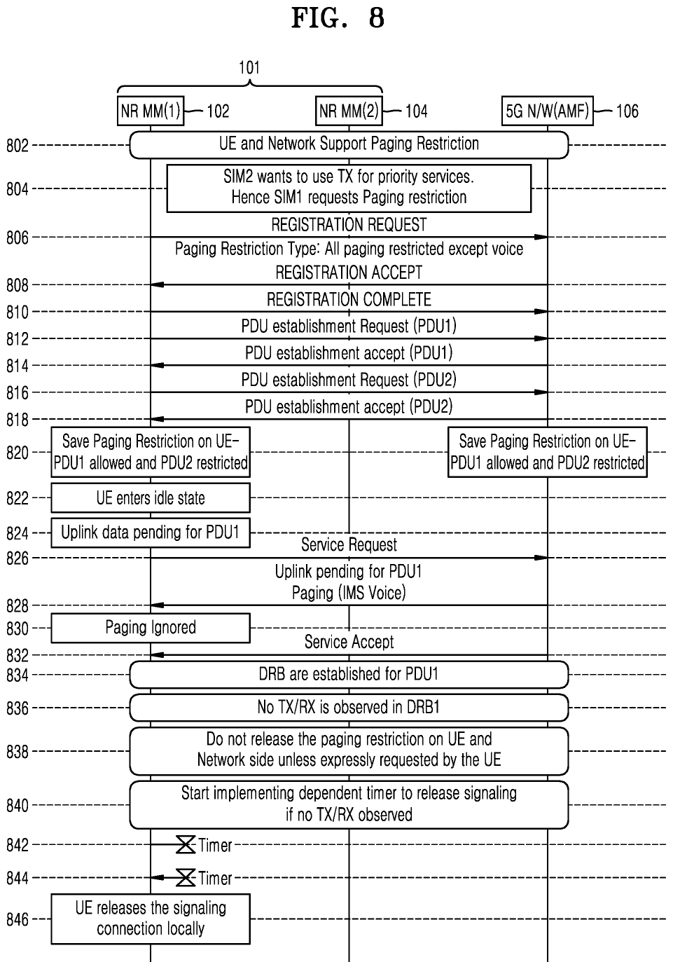

FIG. 8 illustrates a sequence of operation of a method for solving the problem of FIG. 7, according to an embodiment of the present disclosure. While the most the steps of FIG. 8 are similar to steps of FIG. 7, the steps 838-848 explicitly relate to the solution of the problem illustrated in FIG. 7.

Specifically, the UE 101 and the network 106 may be configured in such a way that the paging restriction is not released unless explicitly requested by the UE 101, as shown in step 838.

Further, upon determining that there is no transmission (TX)/reception (RX) in DRB established for PDU1, the UE 101 implements a timer to release the signaling connection, as shown in steps 840-842. Particular, in case, the network fails to release or delay in release the signaling connection, the UE 101 may perform the step 840. In an exemplary embodiment, the timer may be a T3540 timer. Further, upon completion of the timer, the UE 101 releases the signaling connection locally, as shown by steps 846-848. Thus, the UE 101 and the network 106 implement an effective and efficient technique to maintain and release paging restrictions and signaling connection. With this the IMS voice paging may also be received subsequently.

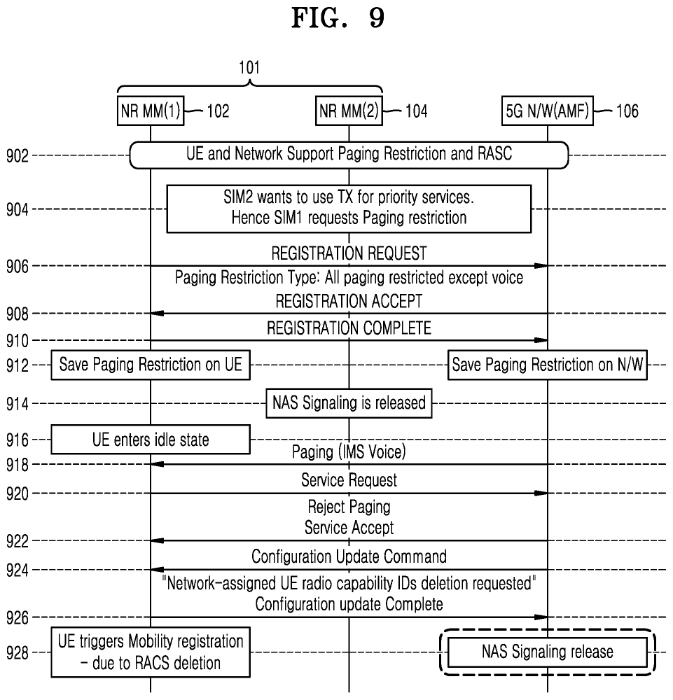

FIG. 9 illustrates a sequence of operation depicting a problem associated with NAS signaling connection, according to the conventional state of art. Steps 902-912 are similar to the steps 402-412, as shown in FIG. 4. Therefore, a description of these steps has been omitted in FIG. 9 for the sake of brevity.

Further, at step 914, upon successful implementation of paging restriction, NAS signaling is released. With release of NAS signaling, the UE 101 enters into idle state, as shown in step 916. At step 918, the AMF 106 transmits a paging for IMS voice to the UE 101. At step 920, the UE 101 transmits a service request in response to received paging. The service request may indicate that the UE 101 intend to reject paging. At step 922, the AMF 106 transmits a service accept message. Next at step 924, the network transmits a configuration update command. The configuration update command may include information such as, but not limited to, deletion of network-assigned UE radio capability IDs, roaming related information, and so forth. At step 926, the UE 101 transmits a configuration update complete message. The configuration update complete message may indicate that the UE 101 has successfully received the configuration update. Thereafter, at step 928, the UE 101 initiates mobility registration based on received configuration update. However, at the same time/signal upon receiving the configuration update complete message, the AMF 106 releases the NAS signaling connection, as shown in step 928. Thus, the steps 928 indicate a conflict of actions by the UE and AMF 106. Specifically, the release of NAS signaling connection by the network may be undesirable to the UE.

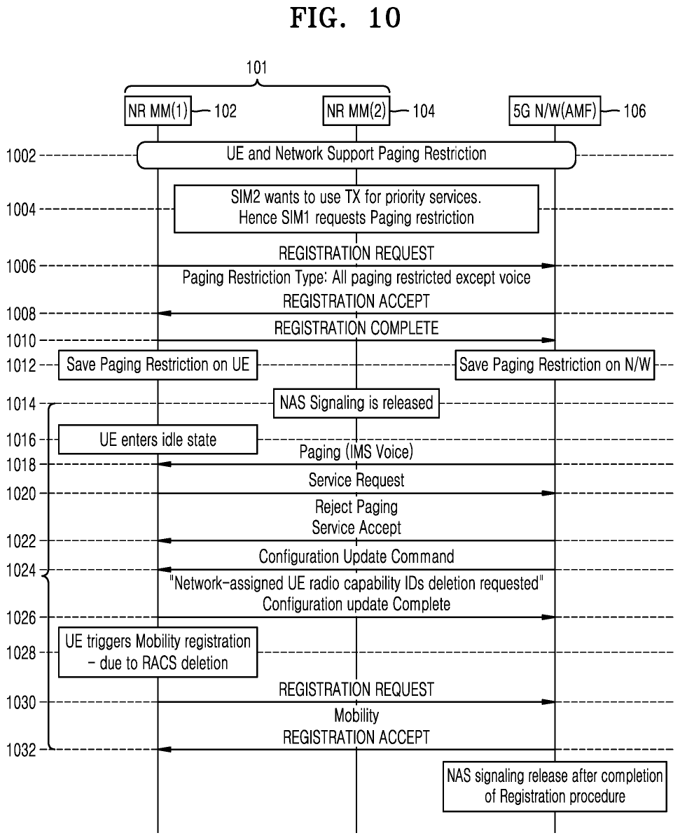

FIG. 10 illustrates a sequence of operation of a method for solving the problem of FIG. 9, according to the conventional state of art. Steps 1002-1026 are similar to steps 902-926, as shown in FIG. 9. Accordingly, a description of these steps has been omitted in reference to FIG. 10 for the sake of brevity.

At step 1028, the UE 101 triggers mobility registration based on the configuration update command. Specifically, the UE 101 may initiate mobility registration due to Radio Capabilities Signaling (RACS) deletion. Also, the network waits till the mobility registration is completed i.e., the network may not initiate the NAS signaling release at step 1028.

At step 1030, the UE 101 transmits REGISTRATION REQUST message for mobility registration. At step 1032, the AMF 106 transmits REGISTRATION ACCEPT message in response to REGISTRATION REQUEST message. Once the registration procedure is completed successfully, the network may release the NAS signaling, as shown in FIG. 10. Thus, the present disclosure enables effective maintenance of the NAS signaling connection.

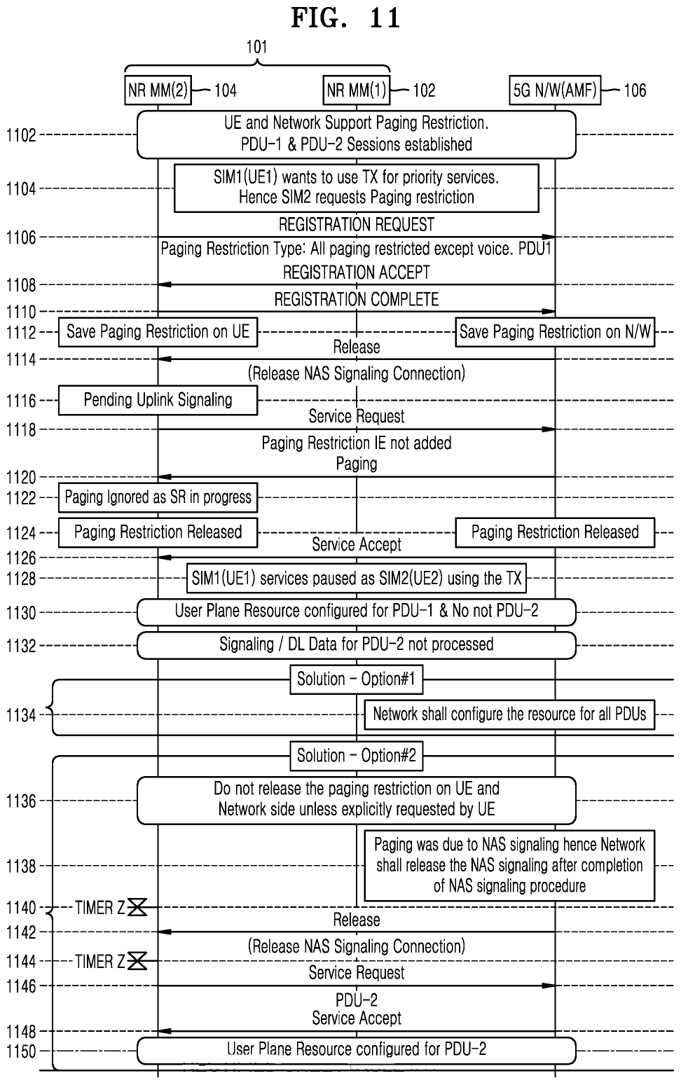

FIG. 11 illustrates a sequence of operation depicting a method for effectively maintaining and releasing paging restriction and NAS signaling connection, according to an embodiment of the present disclosure.

The method may consider an assumption that both the UE 101 and the network 106 support paging restriction, as shown by step 1102. Further, the UE 101 is registered with the network 106, and PDU session 1 and PDU session 2 are established. Moreover, the paging is restricted for PDU session 1 and paging is allowed for PDU session 2. Moreover, in the exemplary scenario, SIM1 102 wants to use transmission (TX) for priority services and therefore, SIM2 104 may request for paging restriction, as shown in step 1104. Based on the same, the SIM2 104 may implement paging restriction between the network 106 and the UE 101, as shown by steps 1106-1112.

Next at step 1114, the network may release the NAS signaling connection. At step 1116, the UE 101 may determine a pending uplink signaling for PDU1. Upon determining the pending uplink signaling, the UE 101 may initiate a service request. In an exemplary embodiment, the paging restriction IE is not included in the service request. At step 1120, the network may initiate paging. The UE 101 may ignore the paging as the service request is in progress, as shown by the step 1122. Both the UE 101 and the network 106 may release the paging restriction in response to service response without paging restriction IE, as shown by step 1124. At step 1126, the AMF 106 may transmit a service accept message. At step 1128, the SIM1 102 session may be paused, upon determining the SIM2 104 is using the session. Step 1130 indicates that user plane resources are configured to PDU1 and not for PDU2. Thus, at step 1132, signaling and/or Downlink (DL) data for PDU2 are pending at network and not known to UE 101.

To solve this problem, the network may be configured to configure data radio bearers for all the PDUs, as shown by step 1134.

Alternatively, the network and the UE may be configured in such a way that paging restrictions are not release unless explicitly requested by the UE, as shown in step 1136. Further, the method may include determining that the paging was initiated, as the NAS signaling connection was established. Thus, to solve this problem, the network may be configured to release the NAS signaling connection after completion of NAS signaling procedure, as shown in step 1138. Further, in case the network fails to release NAS signaling connection, the UE may initiate a timer Z to release the NAS connection, as shown in steps 1140-1144. In an embodiment, the timer Z may be any one of timer T3540, a user configured timer, or a timer negotiated between the UE and the network. Further, in case the service requested is initiated for PDU2, user plane resource may be configured to PDU2, as shown in steps 1146-1150.

Thus, the method provides an efficient and efficient way to maintain and release paging restrictions and/or NAS signaling connection.

In the scenario illustrated in FIG. 11, there may be instances when the UE and the network may remain in connected state. The instances may include, but not limited to, pending DL transmission, configuration related signaling and so forth. In such instances, the UE may not be able to release NAS signaling as the network may send DL data. The UE may then implement a timer and wait for the network to release the connection. In case, the network didn't release the connection even after completion of the timer, the UE may locally release the NAS signaling connection.

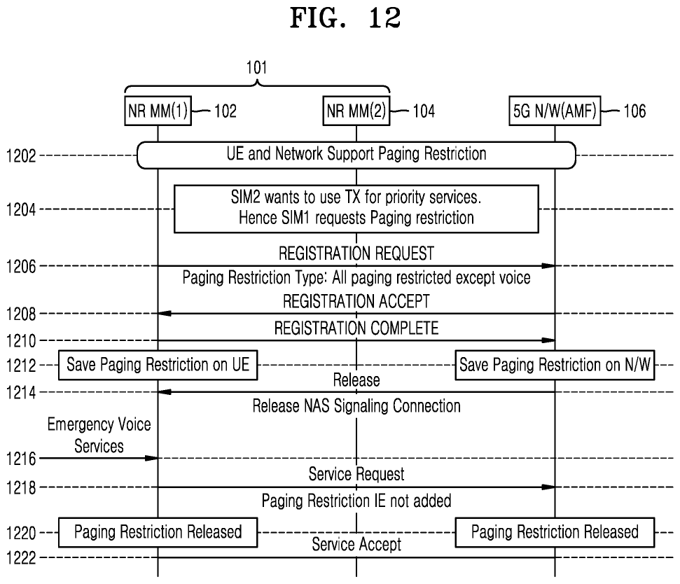

FIG. 12 illustrates a sequence of operation depicting a problem associated with paging restriction, according to the conventional state of art. While most of the steps of FIG. 12 are similar to previously explained FIGS. FIG. 12 illustrates that the paging restrictions saved on the UE 101 and the network 106 may be release, even with transmission of a service request in response to emergency voice services, as shown by steps 1216-1220. To overcome this problem, the method explained in FIGS. 2-3 may be used. Accordingly, the UE 101 and the network 106 may be configured not to release paging restriction unless explicitly requested by the UE 101.

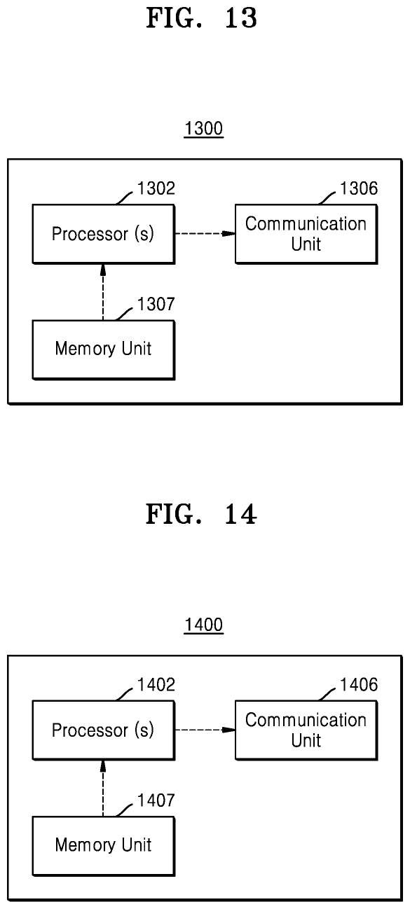

FIG. 13 illustrates exemplary diagram of a network, according to an embodiment of the present disclosure. The network 1300 may correspond to 5GMM, as discussed throughout this disclosure. The network 1300 may include at least one processor 1302, a memory unit 1304 (e.g., storage), and a communication unit 1306 (e.g., communicator or communication interface). Further, the network 1300 may also include the Cloud-RAN (C-RAN), a Central Unit (CU), a core Network (NW), a Distributed unit (DU) or the any other possible network (NW) entity. The communication unit 1306 may perform one or more functions for transmitting and receiving signals via a wireless channel.

As an example, the processor 1302 may be a single processing unit or a number of units, all of which could include multiple computing units. The processor 1302 may be implemented as one or more microprocessors, microcomputers, microcontrollers, digital signal processors, central processing units, state machines, logic circuitries, and/or any devices that manipulate signals based on operational instructions. Among other capabilities, the processor 1302 is configured to fetch and execute computer-readable instructions and data stored in the memory. The processor 1302 may include one or a plurality of processors. At this time, one or a plurality of processors 1302 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 1302 may control the processing of the input data in accordance with a predefined operating rule or artificial intelligence (AI) model stored in the non-volatile memory and the volatile memory, i.e., memory unit 1304. The predefined operating rule or artificial intelligence model is provided through training or learning.

The memory 1304 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

FIG. 14 is a diagram illustrating the configuration of a user equipment (UE) 1400 in a wireless communication system, according to an embodiment of the present disclosure. The configuration of FIG. 14 may be understood as a part of the configuration of the UE 1400. Further, the method as disclosed above may be implemented in the UE 1400 according to a further embodiment. In an embodiment, the UE 1400 corresponds to the UE 101. Hereinafter, it is understood that terms including “unit” or “module” at the end may refer to the unit for processing at least one function or operation and may be implemented in hardware, software, or a combination of hardware and software.

Referring to FIG. 14, the UE 1400 may include at least one processor 1402, a communication unit 1404 (e.g., communicator or communication interface), and a storage unit 1406 (e.g., storage). By way of example, the UE 1400 may be a User Equipment, such as a cellular phone or other device that communicates over a plurality of cellular networks (such as a 3G, 4G, a 5G or pre-5G, 6G network or any future wireless communication network). The communication unit 1404 may perform functions for transmitting and receiving signals via a wireless channel.

As an example, the processor 1402 may be a single processing unit or a number of units, all of which could include multiple computing units. The processor 1402 may be implemented as one or more microprocessors, microcomputers, microcontrollers, digital signal processors, central processing units, state machines, logic circuitries, and/or any devices that manipulate signals based on operational instructions. Among other capabilities, the processor 1402 is configured to fetch and execute computer-readable instructions and data stored in the memory. The processor 1402 may include one or a plurality of processors. At this time, one or a plurality of processors 602 may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors 1402 may control the processing of the input data in accordance with a predefined operating rule or artificial intelligence (AI) model stored in the non-volatile memory and the volatile memory, i.e., memory unit 1404. The predefined operating rule or artificial intelligence model is provided through training or learning.

The memory 1404 may include any non-transitory computer-readable medium known in the art including, for example, volatile memory, such as Static Random Access Memory (SRAM) and Dynamic Random Access Memory (DRAM), and/or non-volatile memory, such as Read-Only Memory (ROM), erasable programmable ROM, flash memories, hard disks, optical disks, and magnetic tapes.

Some example embodiments disclosed herein may be implemented using processing circuitry. For example, some example embodiments disclosed herein may be implemented using at least one software program running on at least one hardware device and performing network management functions to control the elements.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method (200) performed by a user equipment (UE) (101) in a wireless communication system, the method (200) comprising:
transmitting (202), to a network entity (106), a request message including paging restriction information;
receiving (204), from the network entity (106), a request accept message including an indication of an implementation of a paging restriction between the network entity (106) and the UE (101) based on the paging restriction information included in the request message; and
transmitting (206), to the network entity (106), a release request message including information related to a release of the paging restriction for the UE (101) when the UE (101) intend to receive paging messages from the network entity (106).

2. The method (200) as claimed in claim 1, wherein the request message includes at least one of a REGISTRATION REQUEST or a SERVICE REQUEST with “Paging Restriction Information”.

3. The method (200) as claimed in claim 1, wherein the release request message includes at least one of a REGISTRATION REQUST or a SERVICE REQUEST with a “Paging Restriction Release” cause.

4. The method (200) as claimed in claim 1, comprising:
receiving, from the network entity (106), an indication that the network entity supports paging restriction; and
upon receiving the indication that the network entity (106) supports paging restriction, transmitting the registration request message including the paging restriction information.

5. The method (200) as claimed in claim 1, wherein the paging restriction information comprises at least one of one or more services or one or more protocol data units (PDUs) for which the UE intend to implement the paging restriction.

6. The method (200) as claimed in claim 5, comprising:
determining the at least one of the one or more services or the one or more PDUs for paging restriction based at least on a priority level of an activity to be performed by the UE (101).

7. A method (300) performed by a network entity (106) in a wireless communication system, the method (300) comprising:
receiving (302), from a user equipment (UE) (101), a request message including paging restriction information;
implementing (304) paging restriction for the UE (101) based on the paging restriction information included in the request message;
transmitting (306), to the UE (101), a request accept message including an indication of an implementation of a paging restriction between the network entity (106) and the UE (101) based on the paging restriction information; and
receiving (308), from the UE (101), a release request message including information related to a release of the paging restriction for the UE (101) when the UE (101) intend to receive paging messages from the network entity (106).

8. The method (300) as claimed in claim 7, wherein the request message includes at least one of a REGISTRATION REQUEST or a SERVICE REQUEST with “Paging Restriction Information”

9. The method (300) as claimed in claim 7, wherein the release request message includes at least one of a REGISTRATION REQUST or a SERVICE REQUEST with a “Paging Restriction Release” cause.

10. The method (300) as claimed in claim 7, comprising:
transmitting, to the UE (101), an indication that the network entity (106) supports paging restriction.

11. The method (300) as claimed in claim 7, wherein the paging restriction information comprises at least one of one or more services or one or more protocol data units (PDUs) for which the UE intend to implement the paging restriction.

12. The method (300) as claimed in claim 11, wherein the at least one of the one or more services or the one or more PDUs for paging restriction is based at least on a priority level of an activity to be performed by the UE.

13. A method (500) performed by a user equipment (UE) (101) in a wireless communication system, the method (500) comprising:
transmitting (502), to a network entity (106), a service request message indicating a request for a service from the network entity while a paging restriction is maintained between the UE (101) and network entity (106);
receiving (504), from the network entity (106), a service accept message indicating an acceptance of the request for the service when a connection between the UE (101) and the network entity (106) has been established by the network entity (106) based on the service request message;
determining (506) a completion of a signaling procedure over the established connection;
in response to the determination of the completion of the signaling procedure over the established connection, releasing (508) the established connection while maintaining the paging restriction between the UE (101) and the network entity (106); and
transmitting (510), to the network entity (106), a release request message including information related to a release of the maintained paging restriction for the UE (101) when the UE (101) intend to receive paging messages from the network entity (106),
wherein in response to a reception of the release request message, the network entity (106) releases the paging restriction for the UE (101).

14. The method (500) as claimed in claim 13, wherein the completion of signaling procedure indicates at least one of a completion of transmission of data packets or a completion of transmission of signaling messages.

15. The method (500) as claimed in claim 13, comprising:
determining the completion of signaling procedure based at least on one of a Radio Resource Control (RRC) inactive state, no pending uplink (UL) signaling, no pending UL data, or Protocol Data Unit (PDU) with no Data Radio Bearer (DRB) or network reject, or no re-registration required on existing signaling.

16. The method (500) as claimed in claim 13, wherein the established connection is released after the determination of the completion of the signaling procedure and a lapse of a predefined time interval defined in a timer.

17. The method (500) as claimed in claim 13, comprising:
prior to transmitting the release request message, predicting loss of the paging restriction due to at least one of a service process or a registration process;
storing the previously established paging restriction information;
determining the loss of paging restriction due to at least one of the service process or the registration process; and
initiating at least one of another service request or registration request with stored paging restriction information.

18-21. (canceled)

22. The method (200) as claimed in claim 1, wherein in response to a reception of the release request message, the network entity (106) releases the paging restriction for the UE (101).

23. The method (300) as claimed in claim 7, wherein in response to a reception of the release request message, releasing (310) the paging restriction for the UE (101).

24. The method (500) as claimed in claim 13, wherein in response to a reception of the release request message, the network entity (106) releases the paging restriction for the UE (101).
